(19) United States
(12) Patent Application Publication
(10) Pub. No.: US 2005/0231299 A1
(43) Pub. Date: Oct. 20, 2005

(54) Integrated circuit and method for manufacturing same

(76) Inventor: Stefan Kern, Waghausel (DE)

Correspondence Address: KIRSCHSTEIN, OTTINGER, ISRAEL;& SCHIFFMILLER, P.C., 489 FIFTH AVENUE, NEW YORK, NY, 10017, US

(21) Appl. No.: 10/517,301

(22) PCT Filed: May 27, 2003
(86) PCT No.: PCT/IB03/02712

§ 371 Date: Jun. 14, 2005

(30) Foreign Application Priority Data
Jun. 6, 2002 (DE) P.10225042.1

(51) Int. Cl. H01P 1/26

(52) U.S. Cl. 333/22 R

(57) ABSTRACT

An integrated circuit having at least one microstrip line and at least one port, and a method of manufacturing the circuit are used, in particular, for test passes for development purposes during chip production and also during chip manufacture. At least some of the ports and/or microstrip lines in the integrated circuit have a removable, reflection-free termination which is integrated on the chip. The integrated circuit is produced in a first step, with at least some of the ports and/or microstrip lines in the integrated circuit being provided with a removable, reflection-free termination which is integrated on the chip, and in a second step for this termination to be removed from a prescribable selection of the ports and/or microstrip lines.

The invention relates to an integrated circuit and to a method for manufacturing same, which are able to be used particularly for test passes when developing radio-frequency circuits (RF circuits) and also in RF circuit manufacture.

### PRIOR ART

Powerful communications technology and information technology currently plays a prominent role in all important areas of economy and science. A worldwide digital network which can be reached globally without restriction of location and allows individual access to information of all kinds is in the process of construction. Wireless (because they are mobile) communications systems are becoming increasingly important in this context.

Countless new services which use this technology, such as telemedicine and mobile data communication using laptops which are constantly connected to the network, are increasingly being used. Mobile information and communications systems will increase safety and mobility in road traffic, for example using vehicle anti-collision radar and satellite-aided navigation systems.

The result of development is that ever more powerful radio-frequency systems (RF systems) with a high bandwidth and increasing frequencies are becoming necessary. A few examples are mobile radio (0.9 and 1.8-1.9 GHz), satellite-controlled navigation systems (1.5-1.6; 12 and 14 GHz), WLANs (=Wireless Local Area Networks at 5.2 GHz), radio relay (for example 38 GHz for mobile radio base stations) and vehicle anti-collision radar at 77 GHz.

The constant introduction of new services which use radio-frequency technology (RF technology) therefore necessitates higher and higher frequencies, since the frequency bands used to date have in the meantime become very densely occupied. As the frequency increases, however, the wavelength becomes shorter and shorter. As soon as the dimensions of a circuit or the elements thereof reach the order of magnitude of this wavelength, propagation time effects, in particular, need to be taken into account when designing circuits. For this reason, attempts are being made to make the circuit dimensions smaller and smaller. This reduction in size is possible using monolithically integrated microwave circuits (MMIC=Microwave Monolithic Integrated Circuits). With this technology, all the circuit elements required for manufacture are attached to a semiconductor material using thin-film technology in a plurality of processes. Since no hybrid elements, as in the case of the integrated microwave circuits (MIC), are used, further miniaturization is possible. As compared with MICs, MMICs afford other advantages too. Thus, an MMIC circuit is much more reliable than an MIC circuit, since there are no subsequently attached components which could become detached. MMICs have smaller production variations and can therefore be reproduced better.

A line technology established to date for MMICs is the microstrip line (microstrip). This line has an earth metallization on the back. The lines and components are attached on the top.

During MMIC development, the individual parts of a circuit, such as amplifiers, mixers, couplers or power splitters, are normally tested individually on their own. If such a radio-frequency circuit (or RF circuit) needs to be measured, then all the ports need to have been connected to the measurement device, such as a radio-frequency probe or RF probe, or else to a termination, the unused ports needing to be terminated on a controlled reflection-free basis in radio-frequency technology. If these controlled reflection-free terminations have not already been implemented on the chip, however, it is difficult—particularly in the range of millimetre wavelengths—to terminate unterminated ports subsequently in a controlled fashion. In such a case in which the ports are terminated subsequently, off-chip termination is referred to. Terminations which have already been implemented on the chip are referred to as on-chip terminations. Owing to the aforementioned drawbacks which arise when using off-chip terminations, it is often preferred for the controlled, reflection-free terminations to be integrated on the chip previously, even though this relinquishes the flexibility which the off-chip terminations would allow. This is a drawback of the on-chip terminations terminated with the required quality on a controlled reflection-free basis, because when using the on-chip terminations, that is to say when a permanent, integrated termination is used for the ports which are unused during measurement, every port termination which is required for a measurement needs to have been implemented on the chip. This means that the same circuit needs to be placed on the test chip a number of times, because it requires different port terminations.

Although it is also possible to use a type of electronic on-chip switches, this option is rarely used because these non-linear switches entail another drawback in that a matched, reflection-free termination is likewise difficult to produce when they are used, and also distortions are caused.

### ADVANTAGES OF THE INVENTION

The invention is therefore based on the object of developing an integrated circuit and a method for manufacturing same which overcome the aforementioned drawbacks, specifically with respect to material consumption and flexibility in the case of test passes for chip development and for chip manufacture, and which at the same time provide the respective matched reflection-free terminations which are required.

The invention achieves this object by virtue of the features in the characterizing part of Claims 1 and 11 in interaction with the features in the precharacterizing part. Expedient refinements of the invention are contained in the subclaims.

A particular advantage of the integrated circuit is that at least some of the ports and/or microstrip lines in the integrated circuit have a removable, reflection-free termination which is integrated on the chip.

A method for manufacturing an integrated circuit involves an integrated circuit being produced in a first step, with at least some of the ports and/or microstrip lines in the integrated circuit being provided with a removable, reflection-free termination which is integrated on the chip, and in a second step this termination being removed from a prescribable selection of the ports and/or microstrip lines provided with the removable, reflection-free termination which is integrated on the chip.

Another advantage of the invention is that the integrated circuit is in the form of an MMIC circuit. It is likewise found to be advantageous that the integrated circuit is in the form of a radio-frequency circuit.

One preferred embodiment of the inventive integrated circuit is that the integrated circuit is in the form of a test circuit.

It is also found to be advantageous that the ports in the integrated circuit are in the form of coplanar line ports.

Another advantage of the inventive integrated circuit is that the integrated circuit has at least one amplifier and/or one mixer and/or one coupler and/or one power splitter.

In one preferred embodiment of the invention, all the ports and/or microstrip lines in the integrated circuit have a removable, reflection-free termination which is integrated on the chip.

It is likewise found to be an advantage of the inventive circuit that input Lange couplers arranged on a chip have at least one port having a removable, reflection-free termination which is integrated on the chip.

Another advantage is that the removable, reflection-free terminations which are integrated on the chip are in the form of absorbing resistors.

It is also found to be advantageous that the removable, reflection-free terminations which are integrated on the chip are arranged symmetrically with respect to radio-frequency signal lines.

4

One preferred embodiment of the inventive method involves, in the first step of the method according to Claim 11, all the ports and/or microstrip lines in the integrated circuit being provided with a removable, reflection-free termination which is integrated on the chip.

It is likewise found to be advantageous that absorbing resistors are used for the removable, reflection-free terminations which are integrated on the chip.

Another advantage of the inventive method is that the position and dimensions of removable, reflection-free terminations which are integrated on the chip are optimized for a reflection-free termination.

It can also be regarded as advantageous that the removable, reflection-free terminations which are integrated on the chip are arranged symmetrically with respect to radio-frequency signal lines.

Of advantage is a procedure in which the removable, reflection-free terminations which are integrated on the chip are removed by a laser.

It is also advantageous that the ports and/or micro-strip lines to be opened are selected in the second step of the method according to Claim 11 on the basis of the requirements of the measurement arrangements used for making contact with the radio-frequency connections.

In one preferred refinement of the inventive method, following removal of the removable, reflection-free terminations which are integrated on the chip, the ports and/or microstrip lines which are now open in the integrated circuit are connected to a measurement device. In this case, it is found to be advantageous that a radio-frequency connection is used as the connection to the measurement device.

In addition, in one preferred refinement of the inventive method, the measurement device is used to test individual parts of the integrated circuit, such as amplifiers, mixers, couplers and/or power splitters, individually on their own.

It is likewise found to be an advantage that the removal of removable, reflection-free terminations which are integrated on the chip stipulates properties of the integrated circuit.

In particular, in one preferred refinement of the inventive method, the removal of removable, reflection-free terminations which are integrated on the chip stipulates the suppressed sideband of a mixer.

The invention provides a termination for radio-frequency ports (RF ports) which is integrated on the chip and is suitable for making contact using a radio-frequency probe (RF probe). This makes it possible to save a large area on the “tile”. The tile refers to the (limited) area which is available for designing new chips and can be used for test passes during development work.

Whereas n*(n−1)/2 test objects were conventionally required for an n-port device, for example, precisely one test object is needed when employing the invention.

The invention can also be used to provide alternative radio-frequency ports on an MMIC circuit which are able to be opened selectively according to requirements while the rest of the ports are kept terminated. This can be used advantageously not just when developing radio-frequency circuits but also when manufacturing these circuits, for example in order to select the suppressed sideband of a sideband mixer by virtue of one of the two ports of the input Lange coupler being connected while the other is kept terminated.

Advantageous refinements of the invention can be found in the features cited in the subclaims.

### DRAWINGS

The invention will be explained in more detail below using an exemplary embodiment illustrated at least in part in the Figures, in which:

FIG. 1 shows a design for a conventional pad for radio-frequency probes (RF probe pad);

FIG. 2 shows a design for an RF probe pad provided with removable terminations;

FIG. 3 shows an attenuation curve to illustrate the transmission when the port is terminated for the purpose of checking the quality of the termination, and

FIG. 4 shows an attenuation curve to illustrate the transmission when the termination has been removed by “lasering away”.

### DESCRIPTION OF THE EXEMPLARY EMBODIMENT

The exemplary embodiment of the invention will be illustrated below using the design of a coupler in a radio frequency circuit. However, the invention can be used suitably not just for this specific example, but rather generally during chip development and also during manufacture, for example in order to select the top or bottom sideband for an integrated mixer.

To design new chips, there is generally only a limited area available—the “tile” or “recticle”. The tile or recticle corresponds to the photomask, on which a plurality of different chip designs can be held. Of this mask, a plurality are accommodated on the wafer, however. For this reason, a large number of identical chips are ultimately obtained from this design. To date, it has been necessary to accommodate a respective coupler on the tile for each combination of the coupler's measurement ports which is to be rated. With the inventive method, precisely one embodiment of the coupler is needed. This then later likewise yields a large number of copies whose ports can be opened differently, according to the requirements of the respective measurement. To date, for an n-coupler, if all combinations of ports (that is to say n*(n−1)/2) needed to be rated, a special coupler design would have been needed for all these n*(n−1)/2 variants, which then also provide a large number of copies—generally more than are needed. Surface area is thus saved on the tile. This naturally also means that the end effect is that the corresponding chip area is saved.

To avoid the aforementioned drawbacks, particularly the need to implement the same circuit on the (test) chip a plurality of times, the invention proposes a removable, reflection-free termination for the ports which is integrated on the chip.

The inventive removable termination can serve as a termination, by way of example, for microstrip lines 1 and/or coplanar line ports which can be opened in order to permit a radio-frequency connection to the port. This means that a single circuit whose ports are respectively equipped with a removable, reflection-free termination which is integrated on the chip can be used for any measurement arrangements. Thus, the inventive controlled termination suitable for making contact with RF connections reduces the area requirement on the tile, and hence ultimately also the chip area requirement, when carrying out test passes for development purposes. (In chip production, the chip area is limited, whereas a wafer normally yields a plurality of identical chips). Generally, it is useful to have alternative RF ports available on an MMIC circuit in order to open them selectively, according to the requirements of the respective measurement, while the rest of the ports are kept terminated. Likewise—as shown above using the example of sideband suppression for a sideband mixer—there are applications in chip manufacture where the use of the invention is found to be advantageous, however.

In order to be able to open a port for the purpose of making radio-frequency contact (RF probing), the inventive termination needs to be removed. This termination replaces the aforementioned electronic, non-linear switches and avoids the drawbacks thereof. In the case of the inventive removable, reflection-free terminations which are integrated on the chip, the absorbing resistors 2 are cut away mechanically by a laser, so that finally a normal configuration is left for radio-frequency probing. When the resistor 2 has been removed by virtue of the resistor coating having been “lasered away”, such an RF port is open for contact to be made by a measurement arrangement.

For terminations of this kind, it is important for the RF port to be terminated in a really controlled manner when the termination has been added, while virtually loss-free transmission needs to be ensured when the resistor 2 has been removed. The most difficult problem needing to be solved in this context is that of converting a normal radio-frequency contact into a good absorber merely by attaching a resistor 2 which terminates in a controlled manner.

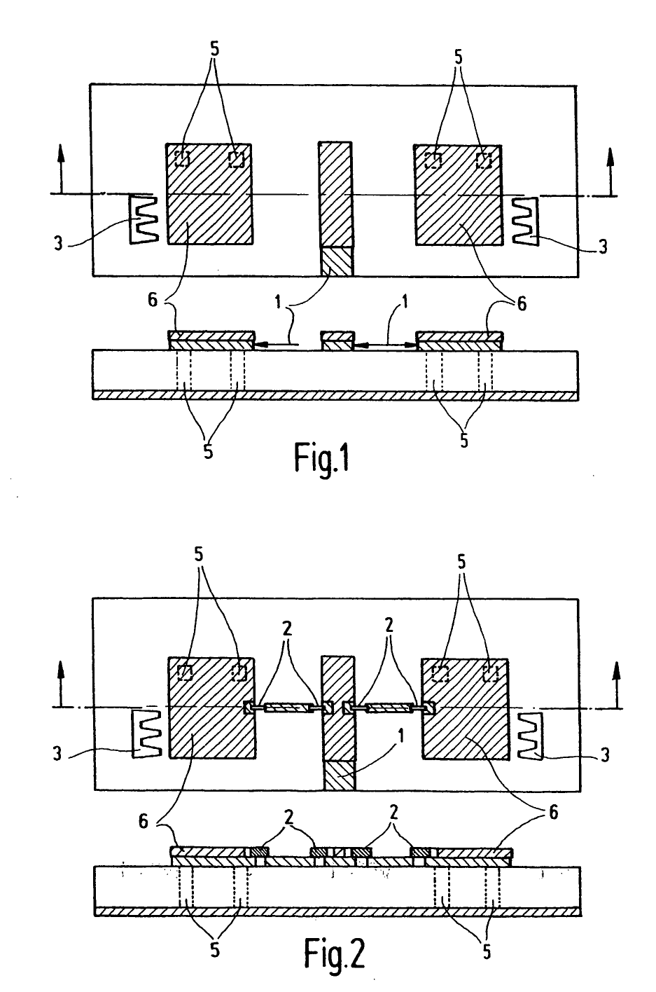

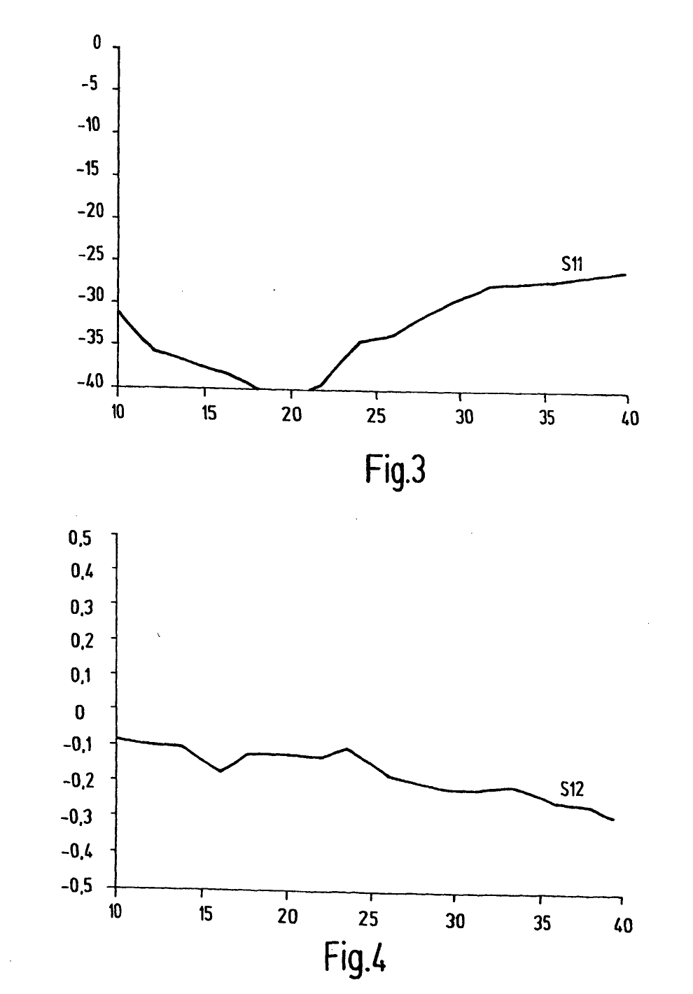

FIG. 2 shows an example of such an absorber. In this case, the MMIC substrate is shown in plan view; the underside of the MMIC substrate has been metallized and serves as “ground”. In addition, FIG. 2 shows the position markers 3 which are normal for a connection for radio-frequency probes but can also be dispensed with. The pads for making RF contact 4 are connected to the underlying ground through the via holes 5. While the metal form of the pads for making RF contact 4 is identical to those for a conventional connection for making RF contact 4 (cf. FIG. 1), two resistors 2 are arranged symmetrically with respect to the RF signal line. In this case, the position and dimensions of the resistors 2 have been optimized in order to produce the controlled termination, as can be seen in FIG. 3. The transmission when the termination has been removed is shown in FIG. 4. In this case, a small amount of attenuation arises which is typically 0.1 dB to 0.3 dB and is caused as a result of a slight conductivity in the substrate material when the resistors 2 have been removed by a laser. For the purposes of the measurements which are to be performed, this RF connection is sufficient, however.

The typical measurement for a multiport proceeds as follows:

For each tile—that is to say on the limited design area—there is a coupler design, for example, where all the ports have been terminated using the inventive removable, reflection-free termination which is integrated on the chip. However, many, for example m, chips are obtained with this one design, in which case the conventional method would be used to obtain m times n*(n−1)/2 couplers. This is in contrast to what is now only m copies.

For every combination of measurement ports which is to be rated, the corresponding inventive terminations are removed from at least one copy in each case, so that the necessary n*(n−1)/2 measurement objects are obtained as a result.

The formula n*(n−1)/2 is obtained as follows:
Example: 4-port coupler:

For this, six combinations are required:
Port 1<--->Port 2
Port 1<--->Port 3
Port 1<--->Port 4
Port 2<--->Port 3
Port 2<--->Port 4
Port 3<--->Port 4

With a large number of real couplers, this number is reduced by symmetries, however, but two designs would nevertheless be needed at least.

The invention is not limited to the exemplary embodiments illustrated in the present case. Instead, it is possible to produce other variant embodiments by combining and modifying the said means and features, without departing from the scope of the invention.

1-22. (canceled)

23. An integrated circuit, comprising: at least one microstrip line; at least one port; and a removable, reflection-free termination integrated on a chip, for terminating at least one of the microstrip line and the port.

24. The integrated circuit according to claim 23, in that the integrated circuit is a microwave monolithic integrated circuit.

25. The integrated circuit according to claim 23, in that the integrated circuit is a radio-frequency circuit.

26. The integrated circuit according to claim 23, in that the integrated circuit is a test circuit.

27. The integrated circuit according to claim 23, in that the at least one port is a coplanar line port.

28. The integrated circuit according to claim 23, and comprising at least one of an amplifier, a mixer, a coupler, and a power splitter.

29. The integrated circuit according to claim 23, in that there is a plurality of microstrip lines, ports and terminations, each of the microstrip lines and ports being terminated by a respective one of the terminations.

30. The integrated circuit according to claim 23, and comprising input Lange couplers on the chip, the couplers having at least one port terminated by the termination.

31. The integrated circuit according to claim 23, in that the termination is an absorbing resistor.

32. The integrated circuit according to claim 23, in that there is a plurality of reflection-free terminations arranged symmetrically with respect to radio-frequency signal lines.

33. A method of manufacturing an integrated circuit, comprising the steps of: integrating at least one microstrip line, at least one port, and at least one removable, reflection-free termination on a chip; and removing the termination from a prescribable selection of at least one of the microstrip line and the port.

34. The method according to claim 33, in that the integrating step is performed by integrating a plurality of microstrip lines, a plurality of ports, and a plurality of terminations on the chip, and by terminating each of the lines and the ports with a respective one of the terminations.

35. The method according to claim 34, in that the terminating step is performed by using absorbing resistors as the terminations.

36. The method according to claim 34, in that the terminating step is performed by selecting and optimizing a position and dimensions of the terminations to be reflection-free.

37. The method according to claim 34, and arranging the terminations symmetrically with respect to radio-frequency signal lines.

38. The method according to claim 34, in that the removing step is performed by a laser.

39. The method according to claim 34, in that the removing step is performed in response to requirements of measurement arrangements used for making contact with radio-frequency connections.

40. The method according to claim 34, in that, following removal of the terminations, performing the step of connecting the ports and microstrip lines to a measurement device.

41. The method according to claim 40, in that a radio-frequency connection is used as a connection to the measurement device.

42. The method according to claim 40, and the step of using the measurement device to test individual parts of the integrated circuit, individually on their own.

43. The method according to claim 34, in that the removal step stipulates properties of the integrated circuit.

44. The method according to claim 34, in that the removal step stipulates a suppressed sideband of a mixer.
